(19) United States
(12) Patent Application Publication
(10) Pub. No.: US 2002/0165970 A1
(43) Pub. Date: Nov. 7, 2002

(54) System and method for intelligent bit rate and buffer selection

(76) Inventor: Carl Ludewig, Mill Valley, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/848,108

(22) Filed: May 2, 2001

(51) Int. Cl. G06F 15/16

(52) U.S. Cl. 709/228

(57) ABSTRACT

A computer-implemented method comprising: transmitting a test file to a client; timing the transmission of the test file with a timer; resetting the timer and reattempting the transmission of the test file if the timer reaches a first maximum threshold value; and calculating an effective bitrate for delivering data to the client based on transmission time of said test file.

### BACKGROUND

1. Field of the Invention

This invention relates generally to the field of digital audio and video delivery systems. More particularly, the invention relates to a system and method for determining an appropriate bit rate with which to transmit data from a server to a client.

2. Description of the Related Art

Virtually all communication channels are bandwidth-limited in some manner, due to the physical limitations of the underlying transmission medium and/or the signaling limitations of the channel (e.g., the channel's allocated frequency spectrum). For example, a 100 Base-T Ethernet network is capable of providing a total data throughput of 100 Mbps, which is shared by all nodes (e.g., clients and servers) on the network. Similarly, the maximum throughput available to home computer users varies widely, ranging between 14.4 kbits/sec and 56 kbits/sec for standard dial-up lines, up to 144 kbits/sec for Integrated Services Digital Network (“ISDN”) lines, and up to 8 Mbits/sec for digital subscriber lines (“DSL”).

Because of the wide disparity in data throughput available to consumers, Internet content is frequently formatted and delivered at a variety of different quality levels (typically, the higher the quality, the more throughput required for playback). In addition, content formatted for transmission over a high speed channel such as DSL may not be suitable for transmission over a low-speed channel such as standard dial-up. For example, a CD-quality audio file may be streamed to a client over a DSL connection with only a few seconds of buffering delay at the client whereas the same file may require several minutes of buffering delay at the client over a standard 56 k modem connection, i.e., a delay which would be unacceptable to most users.

Systems have been developed for measuring the throughput available to an end user and delivering content of a particular quality based on the measured throughput. However, these systems typically calculate available throughput in a relatively simplistic manner—e.g., by measuring the amount of time it takes to transmit a file to the user and dividing the file size by the amount of time. The file size used for these calculations are typically quite large in order to deal with the problem of temporary network glitches (e.g., temporary periods of network transmission delay).

Accordingly, what is needed is a more accurate and efficient system and method for determining the throughput available to an end user. What is also needed is a system and method for selecting content of a particular quality based on the available throughput.

### SUMMARY

A computer-implemented method comprising: transmitting a test file to a client; timing the transmission of the test file with a timer; resetting the timer and reattempting the transmission of the test file if the timer reaches a first maximum threshold value; and calculating an effective bitrate for delivering data to the client based on transmission time of said test file.

### BRIEF DESCRIPTION OF THE DRAWINGS

A better understanding of the present invention can be obtained from the following detailed description in conjunction with the following drawings, in which:

FIG. 1 illustrates an exemplary network architecture used to implement elements of the invention.

FIG. 2 illustrates an exemplary computer architecture used to implement elements of the invention.

FIG. 3 illustrates one embodiment of a system for distributing audio/video content to a client.

FIG. 4 illustrates a Java applet implemented in one embodiment of the invention.

FIG. 5 illustrates one embodiment of a system for intelligent bitrate selection.

FIG. 6 illustrates one embodiment of a method for intelligent bitrate selection.

### DETAILED DESCRIPTION

In the following description, for the purposes of explanation, numerous specific details are set forth in order to provide a thorough understanding of the invention. It will be apparent, however, to one skilled in the art that the invention may be practiced without some of these specific details. In other instances, well-known structures and devices are shown in block diagram form to avoid obscuring the underlying principles of the invention.

### An Exemplary Network Architecture

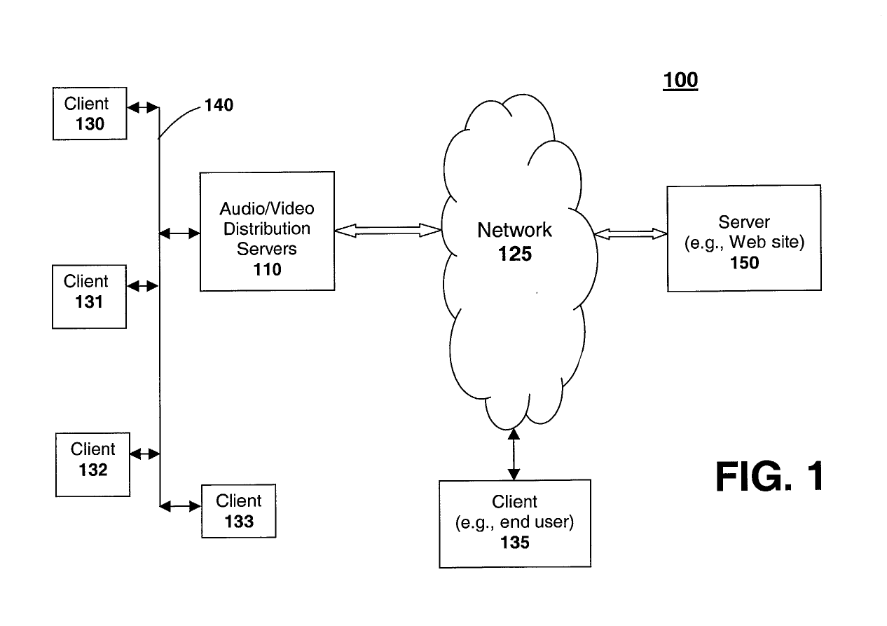

Elements of the present invention may be included within a client-server based system 100 such as that illustrated in FIG. 1. According to the embodiment depicted in FIG. 1, one or more servers 110, 150 communicate to one or more clients 130-133, 135. The clients 130-133, 135 may transmit and receive data from the servers 110, 150 over a variety of communication media including (but not limited to) a local area network 140 and/or a larger network 125 (e.g., the Internet). Alternative communication channels such as wireless communication via satellite broadcast (not shown) and cellular are also contemplated within the scope of the present invention.

The servers 110, 150 may include one or more databases for storing digital audio and/or video data. The databases may also store specific client data (e.g., information on how frequently a particular client logs in to server 110 and that client's preferences) and/or more general data. The database in one embodiment runs an instance of a Relational Database Management System (RDBMS), such as Microsoft™ SQL-Server, Oracle™ or the like.

A client may interact with and receive feedback from servers 110, 150 using various different communication devices and/or protocols. In one embodiment, the client logs in to servers 110, 150 via client software. The client software may include a Java-enabled browser application such as Netscape Navigator™ or Microsoft Internet Explorer,™ and may communicate to servers 110, 150 via the Hypertext Transfer Protocol (hereinafter “HTTP”). In other embodiments included within the scope of the invention, clients may communicate with servers 110, 150 via cellular phones and pagers (e.g., in which the necessary software is embedded in a microchip), handheld computing devices, and/or touch-tone telephones. In addition, the present invention may be used with any device connectable to the Internet in a direct or wireless connection.

### An Exemplary Computer Architecture

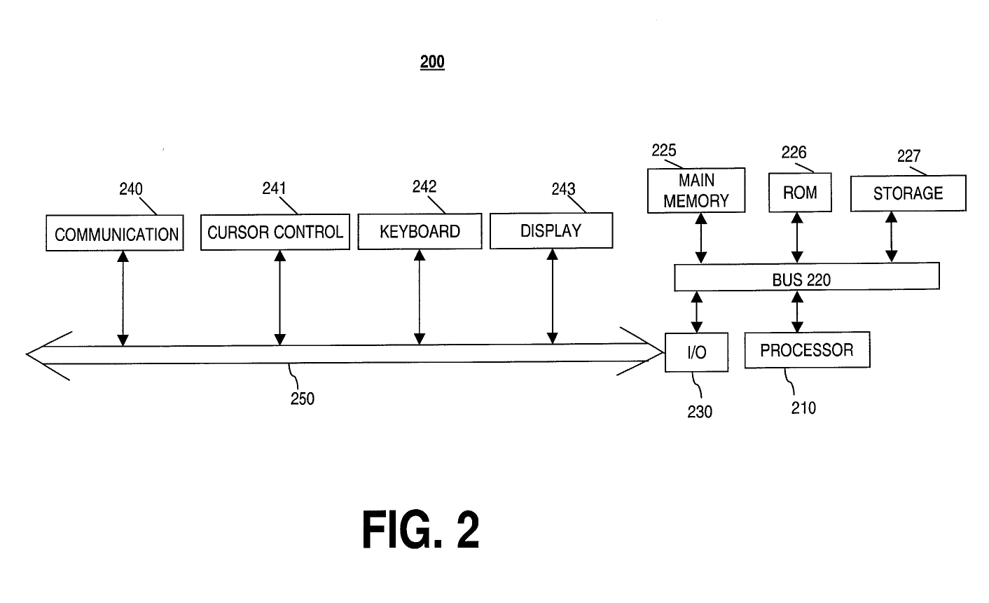

Having briefly described an exemplary network architecture which employs various elements of the present system and method, a computer system 200 representing exemplary clients 130-133, 135 and/or servers 110, 150 in which elements of the system and method may be implemented will now be described with reference to FIG. 2.

One embodiment of a computer system 200 comprises a system bus 220 for communicating information, and a processor 210 coupled to bus 220 for processing information. Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via and I/O interface 230. A plurality of I/O devices may be coupled to I/O bus 250, including a display device 243, an input device (e.g., an alphanumeric input device 242 and/or a cursor control device 241).

The communication device 240 may comprise a modem, a network interface card, or other well known interface device, such as those used for coupling to Ethernet, token ring, or other types of networks. In any event, in this manner, the computer system 200 may be coupled to a number of servers via a conventional network infrastructure, such as a company's local area network 140 and/or the larger network 125, for example.

### Embodiments of a System and Method for Intelligent Bit Rate and Buffer Selection

In one embodiment, the owner/operator of the Internet server 150 is a customer of the owner/operator of the audio/video distribution servers 110, and client 135 is an end user (e.g., a user dialing out to the Internet or connecting to the Internet via a broadband connection such as digital subscriber line). In this embodiment, the owner of the Internet server 150 may contract with the owner of the audio/video distribution servers 110 to provide audio and/or video functionality for the Internet server's 150's Internet site. For example, server 150 may represent an e-commerce customer such as Ticket Master™ Online or The Gap™ Online and the multimedia content used by these customers may be provided by the audio/video distribution servers 110.

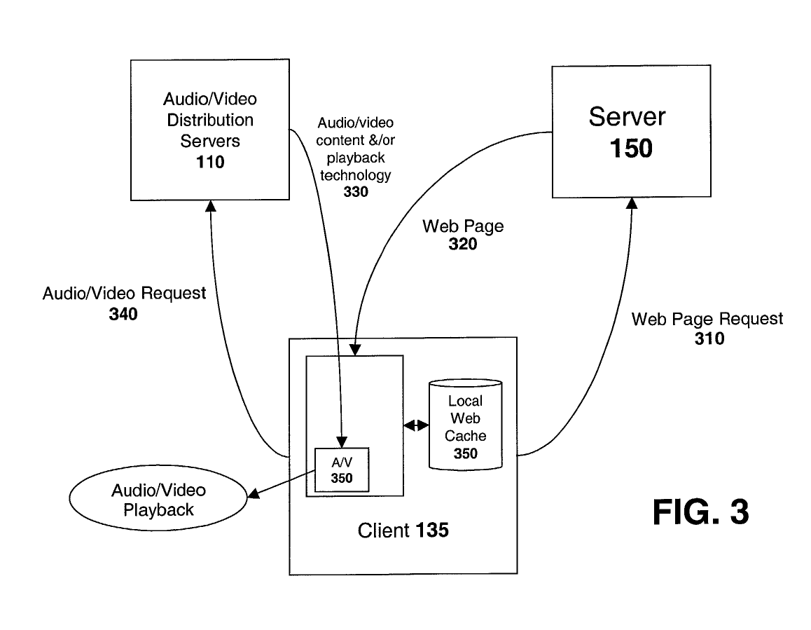

With the foregoing business relationship in mind, FIG. 3 illustrates client 135 communicating over network 125 to audio/video distribution servers 110 and server 150. In one embodiment of the system and method, client 135 initially makes a Web page request 310 from server 150 (e.g., by clicking on a link to that Web page) and, in response, server 150 transmits the requested Web page 320 to client 135. The Web page request 310 may contain more information than a simple Web page address. For example, if client 135 has previously visited server 150, then cookie data identifying client 135 may also be transmitted to server 150. Server 150 may then transmit a Web page 320 to client 135 which contains information uniquely tailored to client 135's preferences. For example, server 150 may be a Ticket Master server from which client 135 has purchased numerous tickets to alternative rock concerts. As such, the Web page 320 transmitted to client 135 may contain specific information relating to upcoming alternative rock concerts, shows, or featured artists.

Audio/video objects 350 may be embedded in Web page 320 which direct audio and/or video associated with the Web page 320 (or components thereof) to be downloaded from the audio/video distribution servers 110 when the Web page 320 is downloaded to the client 135 (or shortly thereafter). In addition, in one embodiment, the audio/video objects 350 may include audio/video streaming, decoding and playback technology (e.g., a Java audio playback applet). This is illustrated in FIG. 3 as an audio/video request 340 from client 135 to the audio/video distribution servers 110, and subsequent audio/video content 330 distribution (with or without playback technology). Although illustrated as two separate servers 110,150, it should be noted that the audio content 330 and the Web page 320 may be transmitted from the same server while still complying with the underlying principles of the invention.

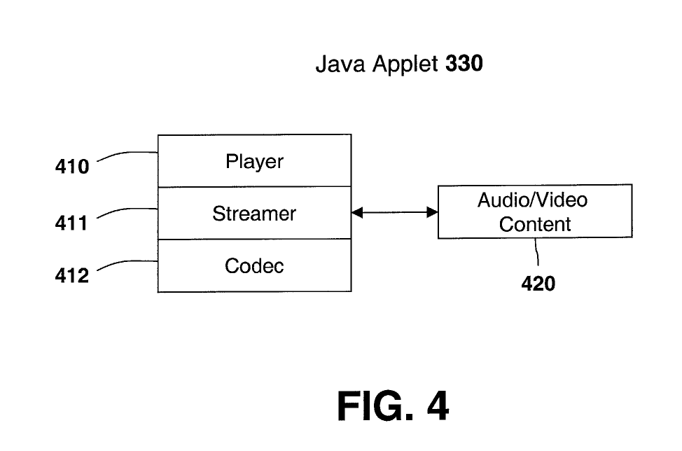

As illustrated in greater detail in FIG. 4, one embodiment of playback technology includes a Java applet which is comprised of an audio/video player module 410, a streamer module 411, a codec module 412 and the underlying audio/video content 420. It should be noted, however, that a Java applet is not required for complying with the underlying principles of the invention. The codec module 412 in one embodiment uses an advanced pulse code modulation (“ADPCM”) codec for compressing/decompressing audio/video content. Accordingly, when audio/video content is to be delivered to a particular end-user, the codec is transmitted along with the content. In one embodiment, the player 410 is transmitted to client 135 in a first network transaction. Secondly, the codec 412 and streamer 411 are transmitted to the client 135. Finally, the content 420 is streamed to the client 135 for decompression by codec 412. In another embodiment, the player 410, codec 412 and streamer 411 are concurrently transmitted to the client followed by the content 420.

In this embodiment, because the player 410 and related modules 411-412 are written in Java, these programs are architecture-neutral. Accordingly, they can be executed on any system which includes a Java virtual machine (virtually all Web browser-equipped machines do). In contrast, browser plug-ins used in prior audio and video streaming systems are platform-dependent (e.g., a plug-in developed for Internet Explorer will not necessarily run on Netscape Navigator and a plug-in developed for a Macintosh™ computer will not run on a PC).

In addition, because Java was designed to create compact programs, the Java applet 330 may be quite small. In one embodiment, the Java applet 330 is slightly more than 4 k-bytes in size, making it ideal for streaming applications where a short transmission time is necessary. One embodiment of the player module 410, streamer module 411, and/or codec module 412 is described in the co-pending U.S. patent applications entitled “A System and Method for Streaming Data in Java,” Ser. No. 09/388,634; and “A System and Method for Providing Audio/Video Content delivery Over a Network,” Ser. No. 09/377,883 which are assigned to the assignee of the present application and which are incorporated herein by reference.

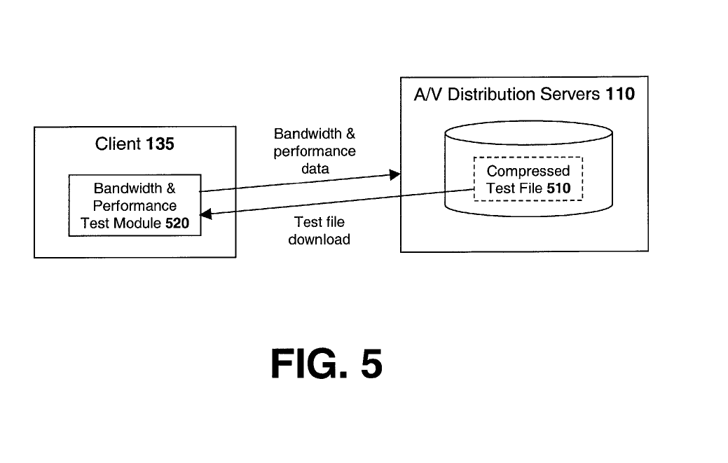

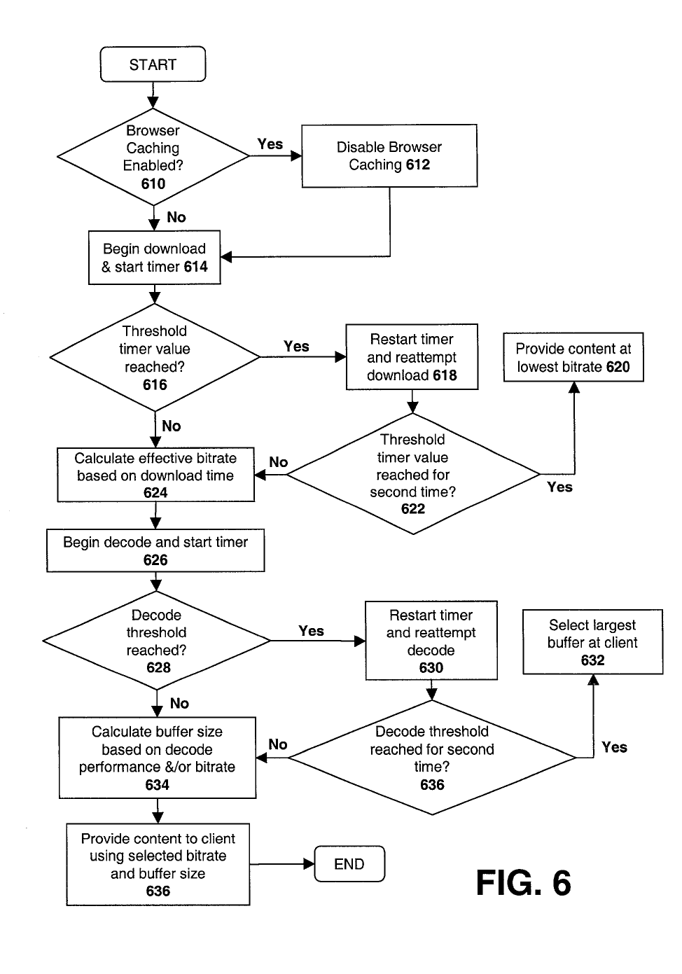

Regardless of the particular type of audio/video streaming technology employed, one embodiment of the invention identifies an appropriate bitrate and/or buffer size to be used for transmitting multimedia content to the client 135. More specifically, in one embodiment, before multimedia content is delivered to a client 135, the system illustrated in FIG. 5 executes the method set forth in FIG. 6 (in whole or in part) to select an appropriate bitrate and buffer size. Initially, at 612 (FIG. 6), if the client's Web browser cache is enabled it is disabled to ensure accurate bitrate calculations (i.e., if test data is read from the cache rather than from the server 110, the effective bitrate will be artificially high).

At 614 one of the audio/video distribution servers 110 begins transmitting a compressed test file 510 to the client 135. In one embodiment, the test file 510 is derived from an audio (or multimedia file) of the same type and format as the one which will typically be streamed on the system. Alternatively, or in addition, the file may be compressed with the maximum level of compression possible (e.g., using G-Zip or other compression application) to ensure accurate throughput calculations. In addition to being highly compressed, in one embodiment the test file is extremely small (i.e., relative to files used in current bitrate test systems). For example, the test file may be just large enough to provide accurate test results. In one specific embodiment, the test file is approximately 6 kbytes in size but the specific size of the test file is not relevant to the underlying principles of the invention.

As the download process is initiated, a test module 520 executed on the client 135 begins timing the download (alternatively, or in addition, a timing module executed on the audio/video distribution servers 110 may time the download). In one embodiment, a threshold timer value is programmed in the system. The threshold timer value approximates the time it would take to provide the test file 510 to the client 135 at the next-to-lowest bitrate provided by the audio/video distribution servers 110. In other words, once this timer value is reached, the only “appropriate” bitrate is the lowest bitrate available. For example, if it takes about 2 seconds to download a 6 K file at say 24 Kbps (the next-to-lowest bitrate in this example), once 2 seconds is reached, a time-out occurs. In other words, the lowest bitrate (e.g., 16 Kbps) codec would need to be selected at this point, so there's no reason to prolong the test.

If the first timer threshold is reached, in order to ensure that the low bitrate approximation was not merely the result of a temporary network glitch (e.g., a temporary period of network transmission delay) one embodiment of the system resets the timer and reattempts the test file 510 download at 618 (FIG. 6). The retry feature may be particularly important in an embodiment which uses a relatively small test file 510 as described above. The same timer threshold value may be used on the second download attempt or, alternatively, a different (longer or shorter) timer threshold value may be used, depending on the embodiment. Regardless of the duration of the second threshold timer value, if it is reached (determined at 622), in one embodiment, the lowest bitrate is selected for communication with the client 135 (at 620). In one embodiment, the system retransmits the test file 510 an additional number of times after the second threshold timer value is reached.

If the test file 510 is successfully downloaded, at 624 the test module 520 (or other module executed on the audio/video distribution servers 110) calculates the effective bitrate based on the download time. For example, if a 6 kbyte file is used and takes 1 second to download, the effective calculated bitrate is (6 kbytes * 8 bits/byte)/1 sec=48 kbits/sec. In one embodiment, the audio/video distribution server 110 uses the calculated bitrate to select an audio and/or video file of a particular quality. In one embodiment, audio/video files may be encoded at a variety of different quality levels, e.g., 16 kbits/sec, 24 kbits/sec, 32 kbits/sec, 40 kbits/sec, 64 kbits/sec, 128 kbits/sec . . . etc. Accordingly, in the foregoing example, the audio/video distribution servers 110 would select 40 kbits/sec as the appropriate bitrate (i.e., because it is the closest bitrate which is lower than the calculated bitrate of 48 kbits/sec). In one embodiment the selection of a bitrate is performed by a query to a lookup table having each of the predefined bitrates stored therein.

In addition to calculating an appropriate bitrate between the audio/video distribution servers 110 and the client 135, one embodiment of the system and method also calculates an appropriate buffer size at the client 135 for receiving an audio/video stream. More specifically, in one embodiment, the client's decompression performance is evaluated and used to determine buffer size. Decompression performance may be based on the hardware and software configured in the client 135 (e.g., the client's CPU speed, the client's browser software including the Java virtual machine, . . . etc.). Accordingly, at 626 a decompression test is initiated on an encoded test file (which may or may not be the same as the test file 510 transmitted during bitrate calculations). In one embodiment, the decompression evaluation is timed in the same manner as the bitrate evaluation. Accordingly, if the decompression process takes longer than some predetermined threshold value, determined at 628, then at 630 the decompression timer is reset and the decompression test is attempted again. If the second attempt also runs longer than the second threshold timer value (which may or may not be the same as the first timer value), determined at 636, the largest buffer size available is selected at the client 135 (at 632) (i.e., to compensate for the slow decoding). However, it should be noted that a retry on the decompression test is not required for complying with the underlying principles of the invention.

If the decompression process terminates before the threshold timer value is reached, at 634 the buffer size is calculated based on the speed of the decompression process. Generally speaking, the slower the client's decompression performance, the larger the calculated buffer size. Moreover, the previously-evaluated bitrate may also be factored into the buffer calculations. For example, if the communication channel between the client 135 and the audio/video distribution servers 110 can support a relatively high bitrate (e.g., via a DSL connection) and the client decompression performance is relatively slow (e.g., because of a slow CPU) then a relatively large buffer will need to be selected so that an overflow condition does not result (i.e., so that the buffer does not fill up due to the slow decompression process). Similarly, if the channel between the client 135 and the audio/video decompression servers 110 supports a relatively low bitrate (e.g., a 36.6 kbit/sec modem connection) and the client's 135's decompression performance is relatively fast, then a small buffer (or no buffer at all) may be selected. In one particular embodiment, a default buffer size is configured within the system (e.g., 5 seconds) and is adjusted up or down depending on the bitrate and buffer analysis described above.

At 636, after the bitrate and buffer size have been determined, the underlying audio/video content is provided to the client 135 (e.g., via an audio/video stream or other content delivery mechanism).

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although some of the embodiments described above focus on an implementation using Java applets executed at a client 135, the system and method for intelligent bitrate and buffer selection may be employed on virtually any system in which one node communicates to another node over a network (e.g., a server to a client over the Internet). Accordingly, the scope and spirit of the invention should be judged in terms of the claims which follow.

What is claimed is:

1. A computer-implemented method comprising:
transmitting a test file to a client;
timing said transmission of said test file with a timer;
resetting said timer and reattempting said transmission of said test file if said timer reaches a first maximum threshold value; and
calculating an effective bitrate for delivering data to said client based on transmission time of said test file.

2. The method as in claim 1 further comprising:
selecting a minimum bitrate for delivering data to said client if said timer reaches a second maximum threshold value and.

3. The method as in claim 1 wherein said test file is compressed using a compression algorithm.

4. The method as in claim 1 wherein said test file is less than 10 kbits in size.

5. The method as in claim 2 wherein said first threshold value is equal to said second threshold value.

6. The method as in claim 1 further comprising:
comparing said effective bitrate to a plurality of available bitrates in a lookup table;
selecting one of said available bitrates based on said effective bitrate; and
transmitting audio/video content to said client at said selected available bitrate.

7. The method as in claim 6 wherein transmitting comprises streaming said audio/video content to said client.

8. The method as in claim 1 further comprising:
decoding a compressed test file at said client;
timing said decoding of said test file with a timer to determine a decompression time; and
calculating a buffer size for incoming data at said client based on decompression time of said test file and/or said effective bitrate.

9. The method as in claim 8 further comprising:
selecting a maximum buffer size at said client if said timer reaches a second maximum threshold value.

10. The method as in claim 1 wherein said test file is derived from media content of a similar type as that typically streamed to said client and other clients.

11. An article of manufacture including a sequence of instructions which, when executed by a processor, cause said processor to:
transmit a test file to a client;
time said transmission of said test file with a timer;
reset said timer and reattempt said transmission of said test file if said timer reaches a first maximum threshold value; and
calculate an effective bitrate for delivering data to said client based on transmission time of said test file.

12. The article of manufacture as in claim 11 comprising additional instructions which cause said processor to:
select a minimum bitrate for delivering data to said client if said timer reaches a second maximum threshold value and.

13. The article of manufacture as in claim 11 wherein said test file is compressed using a compression algorithm.

14. The article of manufacture as in claim 11 wherein said test file is less than 10 kbits in size.

15. The article of manufacture as in claim 12 wherein said first threshold value is equal to said second threshold value.

16. The article of manufacture as in claim 11 comprising additional instructions which cause said processor to:
compare said effective bitrate to a plurality of available bitrates in a lookup table;
select one of said available bitrates based on said effective bitrate; and
transmit audio/video content to said client at said selected available bitrate.

17. The article of manufacture as in claim 16 wherein transmitting comprises streaming said audio/video content to said client.

18. The article of manufacture as in claim 11 comprising additional instructions which cause said processor to:
decompression a compressed test file at said client;
time said decoding of said test file with a timer; and
calculate a buffer size for incoming data at said client based on decompression time of said test file and/or said effective bitrate.

19. The article of manufacture as in claim 18 further comprising:
selecting a maximum buffer size at said client if said timer reaches a second maximum threshold value.

20. A method comprising:
timing a first transmission of a test file to a client;
timing a second transmission of said test file to said client if said test file is not fully received at said client within a first maximum threshold timing value; and
calculating an effective bitrate for delivering data to said client based on transmission time of said test file in said first transmission if said test file is fully received at said client within said first maximum threshold timing value.

21. The method as in claim 20 further comprising:
calculating an effective bitrate for delivering data to said client based on transmission time of said test file in said second transmission if said test file is not fully received at said client within said first maximum threshold timing value.

22. The method as in claim 21 further comprising:
selecting a minimum predetermined bitrate for delivering data to said client if said test file in said second transmission is not fully received at said client within a second maximum threshold timing value.

23. The method as in claim 22 wherein said second maximum threshold timing value is equal to said first maximum threshold timing value.

24. The method as in claim 20 further comprising:
decoding a compressed test file at said client;
timing said decoding of said test file with a timer; and
calculating a buffer size for incoming data at said client based on decompression time of said test file and/or said effective bitrate.

25. The method as in claim 24 further comprising:
resetting said timer and reattempting said decompression of said test file if said timer reaches a first maximum threshold value

26. The method as in claim 25 further comprising:
selecting a maximum buffer size at said client if said timer reaches a second maximum threshold value.
